(19) United States
(12) Patent Application Publication
(10) Pub. No.: US 2007/0123476 A1
(43) Pub. Date: May 31, 2007

(54) Polyene antibiotic for controlling fungal growth in banana crops

(76) Inventors: Angelina Dekker, Delft (NL); Nicole Liliane Dutreux, Delft (NL); Jacobus Stark, Rotterdam (NL)

Correspondence Address: NIXON & VANDERHYE, PC, 901 NORTH GLEBE ROAD, 11TH FLOOR, ARLINGTON, VA, 22203, US

(21) Appl. No.: 10/587,948

(22) PCT Filed: Jan. 31, 2005
(86) PCT No.: PCT/EP05/01052

§ 371 Date: Aug. 2, 2006

(30) Foreign Application Priority Data
Feb. 5, 2004 (EP) 04075366.7

(51) Int. Cl. A01N 43/04

(52) U.S. Cl. 514/28

(57) ABSTRACT

The present invention relates to a process to treat banana plants against disease wherein a polyene antibiotic is applied on the plant. In particular a process is described to protect banana crops from the devastating Sigatoka and Panama diseases. To that effect, banana plants are treated with a preparation comprising an amount of a polyene antibiotic effective to prevent or inhibit mould growth, especially M. fijensis and Fusarium oxysporum f sp. cubense.

### FIELD OF THE INVENTION

The present invention relates to a method for controlling Mycosphaerella and Fusarium growth on banana plants. Mycosphaerella fijiensis and Fusarium oxysporum f sp. cubense, responsible for the so-called black Sigatoka and Panama diseases, result in high losses and represent a real threat for the survival of banana varieties.

### BACKGROUND OF THE INVENTION

Fusarium wilt (Panama disease), caused by Fusarium oxysporum f. sp. cubense, is the most widely spread and, historically, the most important disease of banana. Well-known epidemics devastated based export plantations up to the mid-1900s, and locally consumed cultivars continue to be affected worldwide. The introduction of resistant Cavendish cultivars in the tropics saved the international banana export trade industry during the 1960s. During the 1970's, however, Cavendish bananas succumbed to the disease in subtropical countries such as South Africa.

The disease has spread through plantations in Australia, South Africa and parts of Asia. It is only a matter of time before it reaches the hub of commercial production in Latin America and the Caribbean. No control strategy has been found to be effective in combating the disease, and most success has been achieved by preventative measures such as the isolation of infected plants and the planting of tissue culture plants in disease-free fields. Today, however, Panama disease is again threatening the world banana production.

Nevertheless, the production of banana is most endanger by the Sigatoka leaf spot or the “black leaf streak”, caused by Mycosphaerella fijiensis.

For several decades the less dangerous yellow Sigatoka—a fungal disease caused by Mycosphaerella musicola occurred in banana plantations. The disease attacks leaves during the entire growth period up to the time of harvesting. It initially causes spotting and blotching of the leaf surface that results in necrosis and withering of the leaf tissue. The course of the disease is usually slow but the reduction of the active leaf surface leads to a weakening of the plant and an associated loss in yield. Because of its slow development, it was possible to control the disease by spraying the plants with mineral oil or with a mixture of mineral oil and fungicides.

Black Sigatoka (M. fijensis) occurred for the first time about thirty years ago in some Central American countries. Within 10 years, black Sigatoka became the predominant leaf disease in bananas with a self-accelarating spread to all important banana growing areas in Central and South America, Central and West Africa and wide areas of Asia.

Black Sigatoka differs from yellow Sigatoka in its very much more aggressive occurrence and in a disease cycle twice as rapid. The young leaves are infected even during formation and fade within 4-5 weeks. In addition to attacking all worldwide important banana table varieties, the disease also attacks the plaintain fruit that constitutes the diet of the native population in wide areas of the tropical belt. Black Sigatoka has completely displaced yellow Sigatoka in the most important banana growing areas.

The aggressing and epidemic occurrence of black Sigatoka, especially in the tropical growing regions of America, Africa and Asia with their high rainfalls, leads to a rapid destruction of the banana plants. Infected leaves blacken, become necrotic and disintegrate. Planned production of bananas without appropriate protection against black Sigatoka is no longer possible.

Spraying banana plants with chemicals is currently applied. The benzimidazole fungicides introduced at the beginning of the 1980's were very effective when sprayed at intervals of 2-3 weeks. However, due to the mechanism of action of this class of products and to their frequent application, black Sigatoka developed an almost complete resistance to the benzimidazole deverivates in few years.

For some years, triazole fungicides have been used with good success against black Sigatoka. However, the number of spray applications per year had to be severely limited since their introduction on the market in order to prevent the development of resistance. Despite this measure, a huge decrease in sensitivity has already been observed.

It has been recognized that the world's most popular fruit and a basic staple food for hundreds of millions of people in the developing world—the banana—is under severe threat. M. fijensis and Fusarium oxysporum f sp can cause the extinction of the banana within 10 years. This would be a disaster to the 500 million Africans and Asians that are dependant on the production of bananas.

Producers, who can afford pesticides, spray the cultures up to 50 times a year. This is equivalent to ten times the average frequency applied in intensive agriculture plants of industrialized countries. The sprayings are not only expensive, making up a quarter of production costs, but present a serious risk to workers and a threat to the environment.

Next to the intensive use of pesticides, a much less aggressive method of control is the improvement of cultural methods. An early warning system has been developed to control black Sigatoka. The system is based on weekly observations of symptoms on young leaves plant. That target fungicide applications to specific periods when disease severity is starting to increase and environmental conditions are favourable for disease development.

Cultural methods play an important role in reducing conditions for development of the disease. But, despite these control measures, the survival of edible banana species are seriously threatened by the Sigatoka and Panama diseases. No effective methods of preventing growth of fungal on banana plants, especially the growth of M. fijensis and Fusarium oxysporum f sp. cubense, without risk of development of resistance and without danger for the health of exposed persons and the environment, are presently known.

### DESCRIPTION OF THE INVENTION

The present invention offers a solution to protect banana crops from the devastating Sigatoka and Panama diseases. According to the invention, banana plants are treated with a preparation comprising an amount of a polyene antibiotic effective to prevent or inhibit mould growth, especially M. fijensis and Fusarium oxysporum f sp. cubense.

Suitable examples of polyene antibiotics are natamycin, nystatin, lucensomycin or amphotericin B. The prefered compound is natamycin. The treatment can also be applied by a combination of two or more of the above-mentioned compounds, or with other fungicides. Also included in this invention are derivates of polyene fungicides for example salts of polyene fungicides (e.g. calcium- and barium salts of natamycin), solvates of polyene (e.g. methanol solvate of natamycin) and crystal modifications of polyene fungicides (e.g. as described in the European Patent Publication No. 670676, (1995)).

Unexpectedly, we have found that M. fijensis and Fusarium oxysporum f sp. cubense species were sensitive to low concentrations of natamycin.

Natamycin has been used for more than 30 years to prevent outgrowth of fungi on cheeses and sausages. Such food products are treated by immersion in or by spraying with a suspension of natamycin in water. Alternatively, cheeses and sausages can be covered by an emulsion of a polymer in water containing natamycin. Usually, aqueous suspensions for immension or spraying treatments contain 0.1% to 0.2% w/v of natamycin, while polymer emulsions for coating purposes contain 0.01% to 0.05% w/v natamycin. The MIC (Minimal Inhibition Concentration) of most fungi for natamycin is less than 20 ppm, while its solubility in water is from 30-50 ppm.

Only the dissolved fraction of natamycin has anti-fungal activity. Denaturation of dissolved natamycin is generally sufficiently compensated by dissolution of natamycin present as crystals and by diffusion of dissolved natamycin to the site of contamination.

After many years of continuous use of the antimycotic, natamycin-resistance fungi have never been found. So under normal conditions natamycin will protect plant crops, like banana plants fully against fungal attack.

The polyene fungicide, e.g. natamycin, can be regularly sprayed on banana crops, when the risk of infection is high. When the risk of infection is lower, outside the rainy season, the spray intervals may be longer. Natamycin can be sprayed preventively. The particular advantages of natamycin reside in its effectivity at low concentration and the absence of development of microbial resistance, even after frequent exposures.

Further, natamycin does not present any hazard for the health of exposed personal and to the environment. It is therefore particularly suitable for a combined control strategy with improved cultures measures. It has been recognized that contamination of banana plants by M. fijensis and Fusarium oxysporum f sp can cause the extinction of the banana within 10 years. This would be a disaster to the 500 million Africans and Asians that are dependant on the production of bananas. A method for determining the minimal effective amount of the antifungal compound is described in Example 1. We have found that natamycin is especially effective against the growth of M. fijensis and Fusarium oxysporum f sp. This invention is specifically suitable for protection of banana plants from the Sigatoka and Panama diseases.

Suitable carriers and adjuvants may be solid or liquid and correspond to the appropriate substances ordinarily employed in formulation technology, including mineral substances, solvents, dispersants, wetting agents, thickeners, binders, surfactants, stabiliser, antifoams and antioxydants and any other natural compounds to obtain special effects.

### EXAMPLE 1

This example demonstrates the antifungal effect of natamycin against M. fijensis and Fusarium oxysporum f.sp responsible for huge losses in the banana production and that endanger the survival of banana plants.

The minimal inhibition concentration of these moulds or the minimal effective amount of the antifungal compound was determined using the agar diffusion method, which is well known in the art. Mould spores were grown on agar plates containing different concentrations of natamycin. The concentration of natamycin on which no visible growth could be observed was considered as the minimal inhibitory concentration (MIC) for that particular mould strain. It has been found that the growth of M. fijensis and Fusarium oxysporum f.sp spores was inhibited by natamycin contration between 3 and 7 ppm.

1. Process to treat banana plants against disease wherein a polyene antibiotic is applied on the plant.

2. Process according to claim 1 wherein natamycin is used.

3. Process according to claim 1 whereby thepolyene antibiotic is sprayed on the plant.

4. Use of an polyene antibiotoc to treat Mycosphaerella fijensis or Fusarium oxysporum.

5. Use of natamycin to treat Mycophaerella fijensis or Fusarium oxysprorum.

6. Use of claim 4 whereby the Mycophaerella fijensis or Fusarium oxysporum is present on a plant, preferably a banana plant.
